(19) United States
(12) Patent Application Publication
(10) Pub. No.: US 2013/0136033 A1
(43) Pub. Date: May 30, 2013

(54) ONE-CLICK CONNECT/DISCONNECT FEATURE FOR WIRELESS DEVICES FORMING A MESH NETWORK

(71) Applicants: Abhishek Patil, San Diego, CA (US); Aixin Liu, San Diego, CA (US); Djung N. Nguyen, San Diego, CA (US)

(72) Inventors: Abhishek Patil, San Diego, CA (US); Aixin Liu, San Diego, CA (US); Djung N. Nguyen, San Diego, CA (US)

(21) Appl. No.: 13/305,554

(22) Filed: Nov. 28, 2011

(51) Int. Cl. H04W 84/18

(52) U.S. Cl. 370/255; 370/254

(57) ABSTRACT

According to one embodiment of the invention, a system, electronic device and method are described for creating, connecting or disconnecting from a mesh network. The method comprises a first operation of detecting a duration of time (or number of press) that a mesh networking button of a wireless device has been actuated. Thereafter, in response to actuation of the mesh networking button up to a first predetermined duration (or presses), a first mesh network is created without additional input of information by a user. Optionally, in response to actuation of the mesh networking button for at least a second predetermined duration, where the second predetermined duration being longer (or different number of presses) in time than the first predetermined duration (or button presses), the electronic device issues a request to join a second mesh network detecting previously by the electronic device.

### FIELD

The invention relates generally to the field of wireless device connectivity. More particularly, one or more of the embodiments of the invention relate to a method and apparatus for creating, connecting to or disconnecting a wireless device from a mesh or an ad hoc wireless network based on actuation of a physical or virtual button on the wireless device.

### BACKGROUND

A wireless network provides a flexible data communication system that can either replace or extend a wired network. Using radio frequency (RF) technology, data may be transmitted and received over the air through walls, ceilings and even cement structures without wired cabling. This provides greater freedom and increased flexibility.

Currently, a wireless network operating in accordance with various Institute of Electrical and Electronic Engineers (IEEE) 802.11 Standards (IEEE 802.11a/b/g/n) may be configured in one of two operating modes: infrastructure mode and ad hoc mode. As of today, most installed wireless networks are configured and operate in infrastructure mode where one or more access points (APs) are configured as interfaces for a wired distribution network (e.g., Ethernet). For instance, in infrastructure mode, a laptop computer with a radio network interface card (NIC) is able to establish communications and associate with the AP, and thus, the user of this device is able to access content within servers connected to the wired network.

When operating in ad hoc mode, the radio NIC within each wireless device is allowed to operate in an independent basic service set (IBSS) network configuration. Hence, the wireless devices perform peer-to-peer communications with each other instead of utilizing an AP for supporting such wireless communications. The ad hoc mode also allows users to spontaneously form a wireless LAN. For example, a group of employees with laptops implemented with IEEE 802.11 wireless chipsets may gather at a coffee house and form a small WLAN by switching their NICs to ad hoc mode. As a result, the employees could share presentation charts and spreadsheets without the need for cabling or an AP.

One type of ad hoc network is referred to as a mesh network, which allows for continuous connections and reconfiguration around broken or blocked paths by “hopping” from one wireless device to another wireless device until the destination is reached. Mesh networks differ from other networks in that the wireless devices can all connect to each other via multiple hops without any infrastructure a(e.g., an AP).

One of the technological hurdles that has hampered broader acceptance of mesh networks is the requirement for users to perform multiple actions to join an existing mesh network or to establish a mesh network. In particular, a high level of user interaction is required to join or form the mesh network. For instance, when a wireless device attempts to connect to or establish a mesh network, the user is required to, at that time, create, input and transmit a mesh identifier that is subsequently used by other devices to identifying the mesh network from other networks. Furthermore, at the time of connection, the user is required to create, input and transmit a pass-phrase that must be re-entered for connecting to an existing mesh network. This degree of user interaction tends to scare off those persons who are uncomfortable with participating in networking protocols to formulate and/or utilize mesh networking.

### BRIEF DESCRIPTION OF THE DRAWINGS

The present invention is illustrated by way of example, and not by way of limitation, in the figures of the accompanying drawings and in which:

FIG. 1 is a block diagram illustrating an embodiment of a three-tier wireless ad hoc mesh network.

FIG. 2 is a block diagram illustrating an embodiment of a wireless ad hoc network protocol architecture.

FIG. 3 is a block diagram illustrating an embodiment of a wireless electronic device configured to create or establish a connection with a mesh network.

FIG. 4 illustrates a generic mesh network message packet format according to one embodiment of the invention.

FIG. 5 illustrates an embodiment of an implementation (using Ethernet packet) of a generic format of a mesh network message.

FIG. 6 illustrates an exemplary embodiment of a flowchart outlining operations for creating a new mesh network by a mesh-enabled wireless device.

FIG. 7A illustrates an exemplary embodiment of a flowchart outlining operations for joining an existing mesh network by a mesh-enabled wireless device operating in a first operating mode.

FIG. 7B illustrates an exemplary embodiment of a flowchart outlining operations for enabling connectivity to an existing mesh network by a mesh-enabled wireless device currently connected to the existing mesh network and operating in a second operating mode.

FIG. 8 illustrates an embodiment of the process flow for mesh network detection and authentication between a first wireless device (Node A) requesting connectivity to the existing mesh network and a second wireless device (Node B) regulating connectivity to the existing mesh network.

FIG. 9 illustrates an exemplary embodiment of a flowchart outlining operations by a mesh-enabled wireless device for disconnecting from a mesh network.

### DETAILED DESCRIPTION

In the following description, for the purposes of explanation, numerous specific details are set forth in order to provide a thorough understanding of the present invention. It will be apparent; however, to one skilled in the art that the invention may be practiced without some of these specific details. In addition, the following description provides examples, and the accompanying drawings show various examples for the purposes of illustration. However, these examples should not be construed in a limiting sense as they are merely intended to provide examples of embodiments of the invention rather than to provide an exhaustive list of all possible implementations. In other instances, well-known structures and devices are shown in block diagram form in order to avoid obscuring the details of the disclosed features of various described embodiments.

### I. General Overview

Embodiments of the invention outline a system, a wireless device and method for creating and providing a connection to or a disconnection from a mesh network without substantial user interaction. More specifically, during set-up of a mesh-enabled wireless device, such as during initial power-up or device registration for example, one or more parameters like a network identifier (ID) and master pass-phrase for use during creation and mesh authentication and/or key generation will be entered by the customer. Of course, it is contemplated that such parameters can be changed if the customer decides to make changes to the mesh network setup or participate in another mesh network. After entry, the network ID and/or pass-phrase may be encrypted and stored in a secure location within the wireless device. If the wireless device is creating a mesh network, the network ID and/or pass-phrase can be used as input(s) into logic that generates the network name and a pass-code for that newly formed mesh network. For a device joining an existing mesh network, however, the pass-phrase should be identical to the pass-phrase set for other devices on the existing mesh network so that subsequently generated pass-codes use the same seed value.

According to one embodiment of the invention, in order to create a mesh network, a button (e.g. a physical button or a logical button displayed on a display screen) of a first (mesh-enabled) wireless device is actuated for at least a first predetermined duration (e.g., a “long press” of the button for three or more seconds, for five or more seconds, for twenty or more seconds, etc.). Alternatively, this button, referred to herein as a “mesh networking button,” may be considered “actuated” by a long press once a perceivable event occurs (e.g., color of a light emitting diode “LED” changes, an on-screen message appears, etc.).

Where the mesh networking button is a physical button on the wireless device, it is contemplated that the wireless device may be adapted with one or more counters to generally monitor how long the mesh networking button is actuated. Count values representing an actuation time may be stored and accessible by a processor implemented within the wireless device. However, where the mesh networking button is a logical button on the wireless device, it is contemplated that the wireless device may be adapted with software, executed by the processor, which monitors how long the mesh networking button is actuated. Of course, one embodiment for actuation may monitor the amount of time that the mesh networking button is depressed (i.e. a detectible force is being specifically applied to an area occupied by the mesh networking button).

This particular actuation of the mesh networking button causes the wireless device to create a new mesh network using the pass-phrase. According to one embodiment of the invention, the Network ID is derived from one of the user defined parameters during initial setup of the device (e.g., the pass-phrase). For instance, the Network ID may be derived from the pass-phrase along with certain information from a media access control (MAC) address of the wireless device (e.g., a plurality of bits from the source MAC address such as the last four bits). After creation of the new mesh network, the wireless device runs a mesh/IP protocol to obtain an Internet Protocol (IP) address for itself.

Alternatively, in order to join an existing mesh network, the mesh networking button for the first (mesh-enabled) wireless device is actuated for a second predetermined duration (e.g., a “short press” of less than three seconds, less than five seconds, etc.). The short press of the mesh networking button may cause the first wireless device to perform a network discovery protocol in efforts to locate any mesh networks that are within its signaling vicinity. In particular, the first wireless device seeking to join the mesh network starts a process by broadcasting a request message, which that may be responded to by a second wireless device being part of an existing mesh network and has its mesh networking button actuated. After communications between these wireless devices are established, these wireless devices enter into a mesh authentication phase where the pass-code derived from the pass-phrase is transmitted from the first wireless device to the second wireless device for authentication. Once mesh authentication has passed, the first wireless devices enter an Auto-IP phase to assign an IP address to the first wireless device to complete the protocol.

Additionally, where the first wireless device is already a member of the mesh network, actuation of its mesh networking button for a third predetermined time (e.g., a long press) may cause transmission of a message that ceases communications with the other wireless devices forming the mesh network. This allows the first wireless device to quickly and seamlessly disconnect from the mesh network.

### II. System Architecture

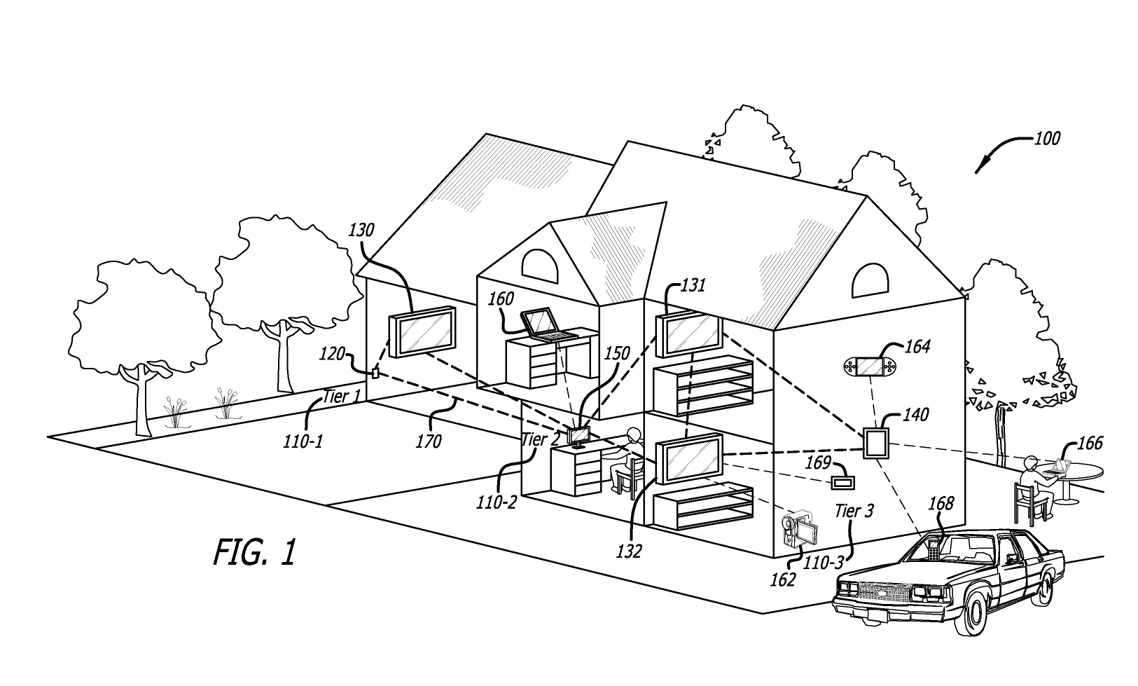

In the following description, certain terminology is used to describe certain features of the invention. For instance, the term “wireless device” is generally defined as an electronic device with data processing and wireless communication capabilities. The term “mesh-enabled” is generally used to describe a characteristic of a wireless device as being manufactured, endorsed and/or sold by the same entity or group of entities, or permitted access to a restricted ad hoc network that collectively features such wireless devices. An example of a group of mesh-enabled wireless devices include, but is not limited or restricted to a Sony® BRAVIA® digital television, Sony® Playstation 3® game console, Sony® VAIO® computer, or other Sony® stationary and handheld devices (e.g., Sony® tablets, Dash™ M or Sony® mobile phones) as illustrated in FIG. 1.

Both terms “logic” and “unit” may constitute hardware and/or software. As hardware, logic (or unit) may include circuitry, semiconductor memory, combinatorial logic, or the like. As software, the logic (or unit) may be one or more software modules, such as executable code in the form of an executable application, an application programming interface (API), a subroutine, a function, a procedure, an object method/implementation, an applet, a servlet, a routine, a source code, an object code, a shared library/dynamic load library, or one or more instructions.

It is contemplated that these software modules may be stored in any type of suitable non-transitory storage medium or transitory computer-readable transmission medium. Examples of non-transitory storage medium may include, but are not limited or restricted to a programmable circuit; a semiconductor memory such as a volatile memory such as random access memory “RAM,” or non-volatile memory such as read-only memory, power-backed RAM, flash memory, phase-change memory or the like; a hard disk drive; an optical disc drive; or any connector for receiving a portable memory device such as a Universal Serial Bus “USB” flash drive. Examples of transitory storage medium may include, but are not limited or restricted to electrical, optical, acoustical or other form of propagated signals such as carrier waves, infrared signals, and digital signals.

The term “interconnect” is broadly defined as a logical or physical communication path for information. Therefore, the interconnect is formed using any communication medium such as a wired physical medium (e.g., a bus, one or more electrical wires, trace, cable, etc.) or a wireless medium (e.g., air in combination with wireless signaling technology).

The term “message” represents information configured for transmission over a network. One type of message is a frame that is generally defined as a group of bits of information collectively operating as a single data unit. Another type of message is a collection of packets or cells. The term “content” includes video, audio, images, data files, or any combination thereof. The terms “actuate” and “actuation” relate to placement into a setting or state which causes another event to occur.

Referring to FIG. 1, an exemplary embodiment of a multi-tier mesh network 100 is described. Multi-tier mesh network 100 (hereinafter referred to as “mesh network”) comprises a collection of wireless devices that operate as a decentralized, mesh network with multiple (N≧2) sub-networks 110₁-110_{N} (hereinafter singularly referred to as “tier”). For this embodiment of the invention, mostly every device of mesh network 100 is configured to forward data to other wireless devices and is assigned to a specific tier based on its performance capabilities and power constraints. Moreover, the assignment of a wireless device to a tier is a decision based on performance capabilities of the wireless device, whereas routing decisions are made by the wireless device based on network connectivity and its ability to forward data.

For instance, one embodiment of mesh network 100 features a hierarchical architecture comprising three (3) tiers that are assigned based on the wireless device capabilities. A first tier (“tier 1”) 110₁ is responsible for establishing and controlling access to an external public network such as the Internet. For example, first tier 110₁ may resemble a traditional Internet connection via a cable or direct subscriber line (DSL) connection or 3G/4G/WiMax®/Outdoor mesh. As illustrated, first tier 110₁ comprises a first wireless device 120, which is commonly referred to as a “gateway node.” Gateway node 120 may include, but is not limited or restricted to a cable or DSL modem, a wireless router or bridge, and the like. Although not shown, multiple gateway nodes may be present within mesh network 100 in order to provide multiple communication paths to external network(s).

A second tier (“tier 2”) 110₂ of mesh network 100 may represent a wireless network backhaul that interconnects wireless devices that tend to be stationary (fixed location) and electrically coupled to an alternating current (AC) power outlet. Examples of a “stationary wireless device” include, but are not limited or restricted to a flat-panel television (130, 131, and 132), a gaming console (140), desktop computer (150), or any other device that is usually stationary and is electrically coupled to an AC power outlet. Hence, stationary wireless devices tend to differ from mobile wireless devices (described below) as they are not subject to power constraints.

Referring still to FIG. 1, a third tier (“tier 3”) 110₃ of mesh network 100 may include interconnects between a stationary wireless device belonging to second tier 110₂ and one or more wireless mobile devices (160, 162, 164, 166, 168 & 169). A “mobile wireless device” may include any battery powered consumer electronics with wireless connectivity including, but is not limited to a cellular telephone, any portable computer including a tablet computer, handheld device (e.g., personal digital assistant, portable media or video game player, wireless camera, remote control, portable music player, etc.) or any non-stationary consumer electronics.

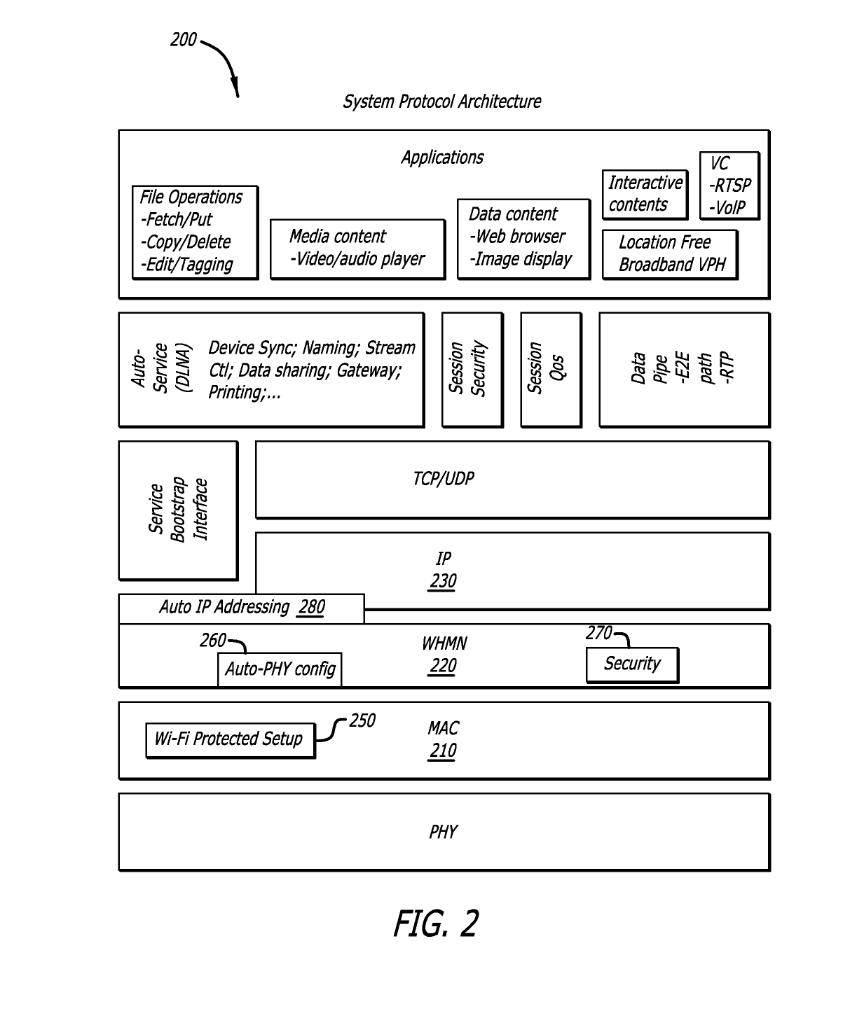

Referring now to FIG. 2, a block diagram shows one embodiment of an Open Systems Interconnection (OSI) layer representation of the system protocol architecture 200 for a mesh-enabled wireless device within mesh network 100 (e.g., wireless device 160 of FIG. 1). Herein, logic within wireless device 160 that is adapted to control the creation of, connection to and/or disconnection from a mesh network is placed within a mesh network (WMN) layer 220 interposed between MAC layer 210 and Network (IP) layer 230. The placement of WMN layer 220, generally considered to be an “OSI layer 2.5,” provides enhanced functionality that is transparent to both lower and higher OSI layers and can be more easily reconfigured.

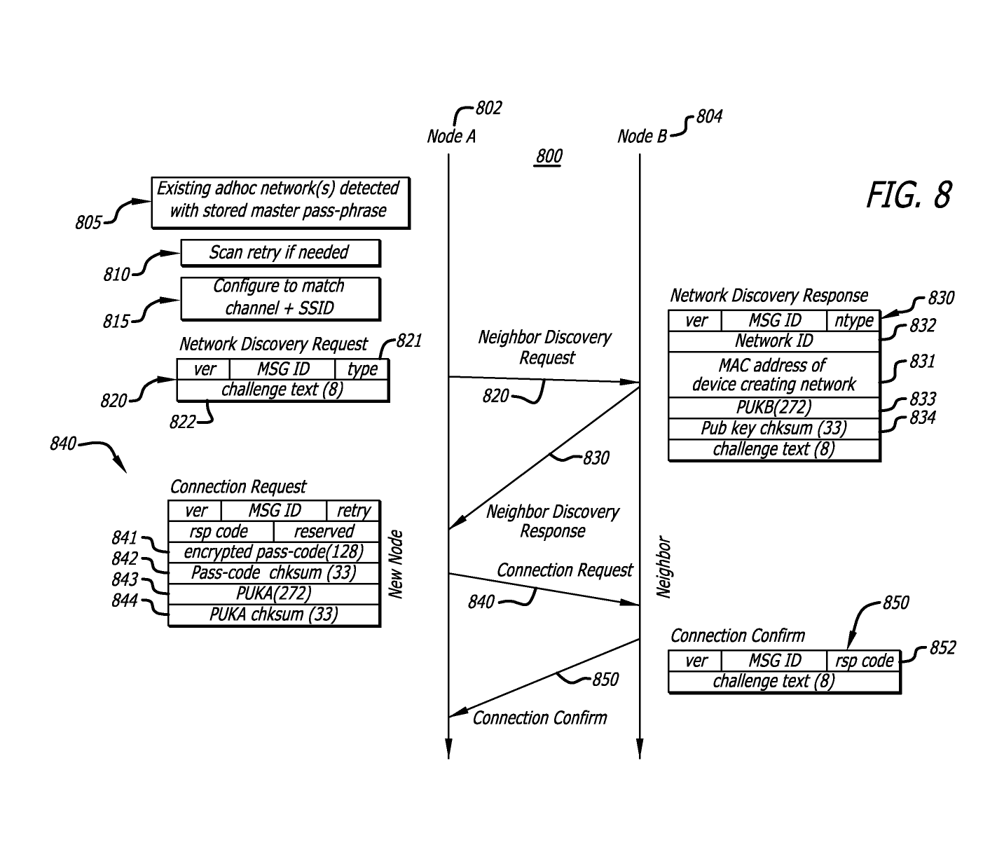

According to one embodiment of the invention, WiFi Protected Setup 250 (logic for setting up the mesh network through button actuation) works integrally with Auto-PHY Configuration logic 260, Security logic 270, and Auto-IP Addressing logic 280. In particular, Auto-PHY Configuration logic 260 is adapted to determine the presence of existing mesh networks. According to one embodiment of the invention, when a wireless device is powered on, Auto-PHY Configuration logic 260 is configured to scan multiple wireless channels in efforts to detect the presence of other mesh networks by broadcasting a mesh location message such as a Network Discovery message set forth in FIG. 8. Additionally, Auto-PHY Configuration logic 260 is adapted to respond to received mesh location messages from other wireless devices.

Security logic 270 is adapted to handle authentication of responding wireless devices to messaging from wireless device 160.

Auto-IP Addressing logic 280 may provide automated Internet Protocol (IP) address generation once a mesh-enabled wireless device has been authenticated and joins a mesh network. More specifically, Auto-IP Addressing logic 280 is adapted to assign a unique IP address to wireless device 160 that is joining a mesh network.

According to one embodiment of the invention, the assignment of the unique IP address may be accomplished by selecting an IP address through the use of the hardware MAC address of wireless device 160 (e.g., MAC address as a seed for a pseudo-random that provides a result within an address range of 192.168.0.1 to 192.168.254.254) and broadcasting the IP address to see if a collision occurs. If so, a new IP address is generated and broadcasted again for collision detection. If no collision detected, the IP address is used by wireless device 160.

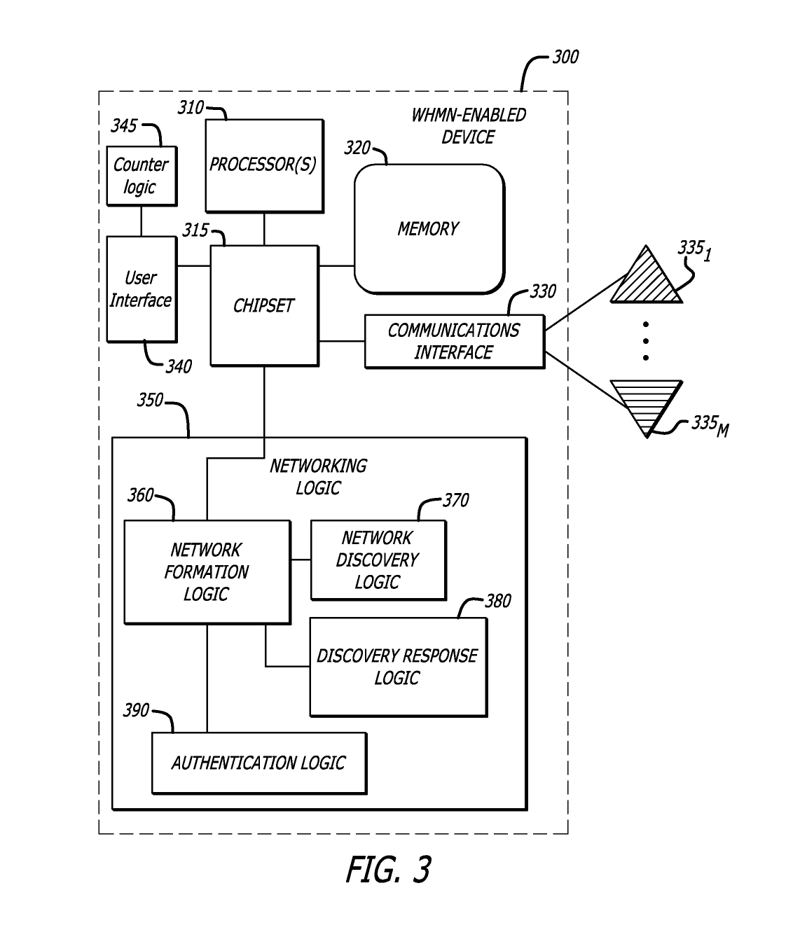

Referring now to FIG. 3, a block diagram illustrating an embodiment of a wireless device 300 configured to create or operate as a part of a mesh network is shown. Herein, wireless device 300, which is a mesh-enabled wireless device such as a tier-2 device (e.g., wireless device 130-132 or 150) or a tier-3 device (e.g., wireless devices 160, 162, 164, etc.) of FIG. 1, comprises one or more processors 310 which use wireless chipset 315 to access memory 320 and communications interface 330. Communications interface 330 may include one or more tunable antennas 335₁-335ₘ (M≧1).

Additionally, wireless device 300 comprises a user interface 340, count logic 345 and wireless ad hoc networking logic 350. User interface 340 may feature a mesh networking button in which count logic 345 monitors the duration of continuous actuation of the mesh networking button. Adapted to control the wireless communications between wireless device 300 and other wireless devices in its vicinity, networking logic 350 includes network formation logic 360, network discovery logic 370, discovery response logic 380, and authentication logic 390.

In one embodiment, when wireless device 300 is powered on, network discovery logic 370 may scan each channel to detect the presence of other mesh networks. According to the IEEE 802.11 Standard, when a wireless card operates in an ad hoc mode, various devices send out messages in a predefined manner according to the ad hoc mode. In one embodiment, when a mesh network is established, including at least one stationary wireless device, the stationary device will periodically transmit a beacon to maintain standard ad hoc operations.

Actuation of wireless device 300 may trigger network discovery logic 370 to perform one or more 802.11 “ad hoc” functions to scan each wireless channel to determine a list of available mesh networks. Based on the detected signals (e.g., beacons), network discovery logic 370 may identify one or more wireless networks that are operating in an ad hoc mode. Network discovery logic 370 may transmit one or more security parameters to detect a mesh network from one or more identified wireless ad hoc networks. These security parameters may enable an existing wireless device within the mesh network to verify wireless device 300 as an electronics device from the same original equipment manufacturer (OEM). Discovery response logic 380 may respond to a network discovery request when device 300 is a wireless device of a mesh network. An authentication process, as shown in FIG. 8, may be performed by authentication logic 390.

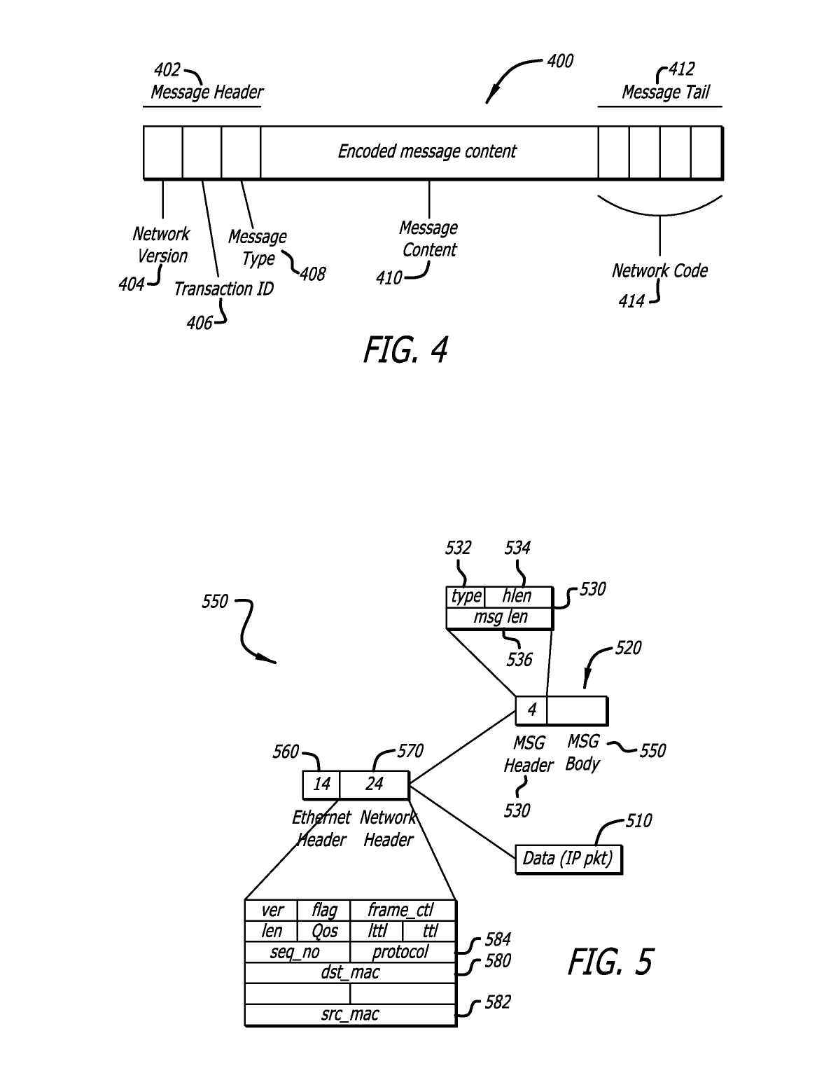

Referring still to FIG. 3, in one embodiment, if wireless device 300 does not detect the presence of a mesh network, network formation logic 360 may enter a network initiator phase to establish device 300 as either a mobile wireless device or a stationary wireless device for a mesh network. For example, referring again to FIG. 1, flat-panel television (TV) 130 may initially become a first stationary wireless device for mesh network 100 of FIG. 1. According to such an embodiment, TV 130 includes a radio NIC which will periodically emit a beacon to enable identification of mesh network 100 by any newly-added electronics devices. For example, desktop computer 150, upon actuation, may detect the presence of mesh network 100 based on a response received from TV 130 in response to a connection request message, which is organized based on a proprietary format as shown in FIG. 4.

### III. System Functionality

FIG. 4 illustrates an exemplary format of a mesh network message 400, which is representative of a messaging format that mesh-enabled wireless device 300 of FIG. 3 uses for initial mesh network setup. For example, during a Network Discovery phase where wireless devices analyze their wireless environment, each new wireless device (e.g. wireless device 160) may run a network scan to locate all wireless networks in its neighborhood. Wireless device 160 then transmits a message as a broadcast or multicast to all identified mesh networks in an attempt to identify a mesh network in its neighborhood. Existing wireless devices of a mesh network respond to the message with appropriate details necessary to establish a new connection.

More specifically, as shown in FIG. 4 as an illustrative embodiment, mesh network message 400 may include (i) a message header 402, (ii) message content 410, and (iii) a message tail 412. Herein, according to this exemplary embodiment, message header 402 includes a mesh network version 404, a transaction (message) ID 406 that identifies the particular message, a type parameter 408 indicates a type of wireless device transmitting the message (e.g., tier-1, tier-2 or tier-3). Message content 410 may include data optionally encoded or encrypted to protect the data from interlopers and to ensure that the data is accessible only by the targeted wireless device. Message tail 412 includes a network code 414. In one embodiment of the invention, each message ends with network code 414 that may be repeated a predetermined number of times to ensure that an entire message is received without error.

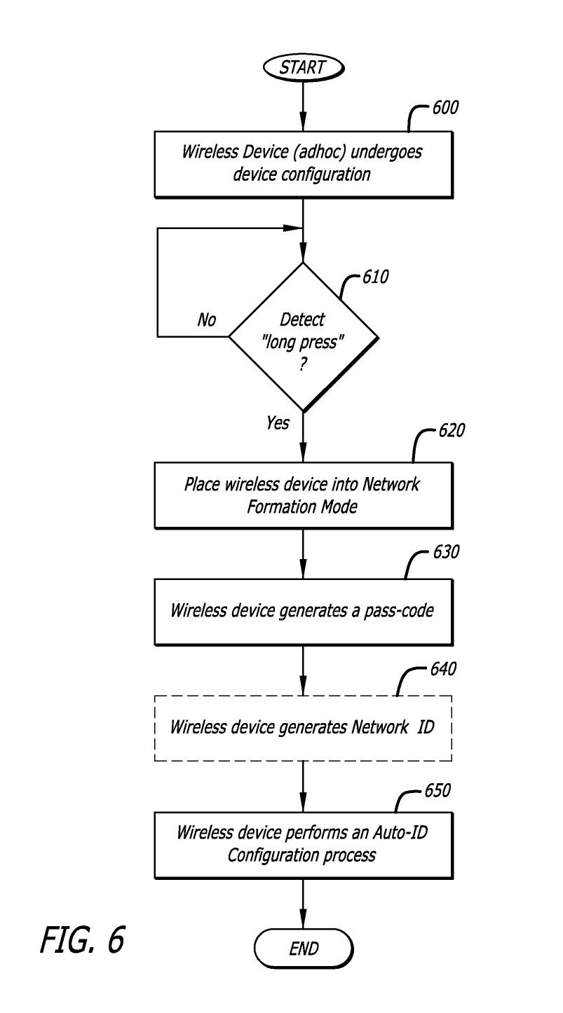

As an example, FIG. 5 illustrates exemplary formats of two types of mesh network messages 400, namely data messages 550 and control messages 520. Herein, according to this embodiment of the invention, both data message 510 and control message 520 are routed by encapsulating these messages within an Ethernet packet 550 that includes a 24-byte header 560 inserted after an Ethernet header 570. Header 560 includes a destination MAC address (dst_mac) 580 to identify a destination for message 400 and a source MAC (src_mac) address 582 to identify a source of message 400. Other information 584 also may be placed within header 570 including, but not limited or restricted to a protocol version number that identifies a version of the system protocol architecture (ver), a frame type as being data or control (frame_ctl), a frame length (len), a QoS feature, a Time-to-Live (TTL) value that specifies how long (in hops) the message is allowed to “live” on the network where each hop causes the TTL value to be reduced by one, a sequence number that indicates the sequence of the frame within a complete message transaction, and a data protocol type.

For control messages (e.g. Network Discovery, Authentication, etc.), 4-byte control header 530 is inserted after header 570, where control header 530 includes type 532 as well as header length 534 and message length 536. After control header 530, a message body (content) 540 of control message 520 is inserted. For Network Discovery messages, for instance, message body 540 is a “challenge text” as described below.

In contrast, for data messages 510, an IP data packet received from the OSI network layer is attached to Ethernet packet 550 after header 570 in lieu of control header 530 and message body 540.

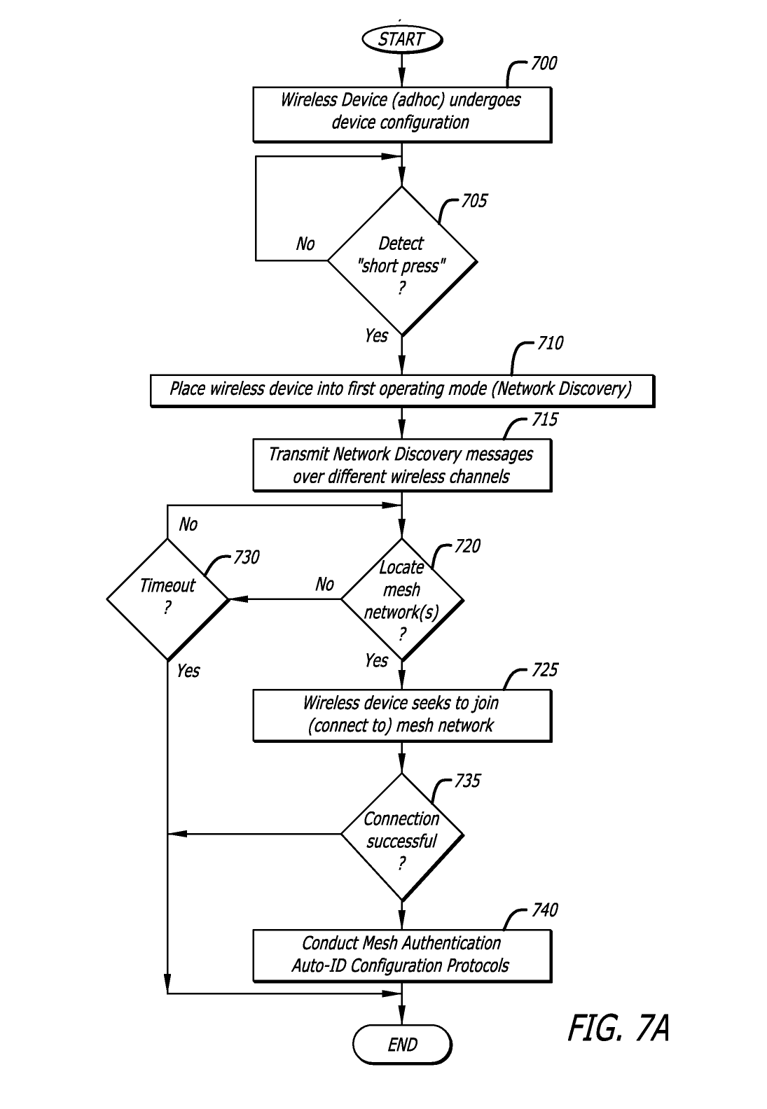

Referring now to FIG. 6, an exemplary embodiment of a flowchart outlining operations by a mesh-enabled wireless device for creating a new mesh network is shown. Prior to creating a new mesh network, such as at initial set-up for example, the wireless device operates in an ad hoc mode and undergoes a device configuration process (item 600). Hence, the device configuration process may be part of the process for setting up the wireless device or registering the wireless device with a manufacturer or an agent of the manufacturer. During the device configuration process, a master pass-phrase (e.g., a string of alphanumeric characters) is input and securely stored within the wireless device (e.g., encrypting the master pass-phrase and storing the encrypted result).

As an illustrative example, the pass-phrase may be input by the user selecting an entry from a menu that is generated and displayed during initial device configuration. Alternatively, the pass-phrase may be input via an input device (e.g., keyboard, keypad, touch screen, etc.) by the user during the device configuration process. For instance, the pass-phrase may be generated from answers in response to one or more questions posed to the user of the wireless device during the device configuration process, or the pass-phrase may be input directly. Another alternative is for the pass-phrase to be formulated based at least in part on the MAC address assigned to the wireless device.

It is contemplated that the Network ID may be set based on user input or automatically where at least a portion of the MAC address assigned to the wireless device is used. The Network ID is used to identify the mesh network as other wireless devices issue may request connectivity to this mesh network and the pass-code is used for authentication. However, it is contemplated that the Network ID may be set later in the process as described below.

Upon detecting a certain style of actuation of the mesh networking button, the wireless device is placed into a Network Formation mode (items 610 and 620). Examples of styles of actuation may include a “long press” being actuation of the mesh networking button for the first predetermined duration, multiple actuations in succession, or the like. When operating in the Network Formation mode, the wireless device generates a mesh pass-code that is subsequently used for mesh authentication (item 630). Optionally, at this time, the Network ID also may be set (item 640).

It is contemplated that the Network ID and the mesh pass-code may be generated using the entire master pass-phrase or at least a portion of the master pass-phrase (e.g., certain bits that form the master pass-phrase). As an example, the Network ID and/or the mesh pass-code may be a result produced by performing a bitwise logical operation (e.g., AND, OR, XOR, etc.) on (i) the master pass-phrase and (ii) bits within the MAC address assigned to the wireless device. As another example, the Network ID and/or the mesh pass-code may be a result produced by performing a concatenation, a hash, or any other arithmetic or logical operation on the master pass-phrase.

This is contemplated that the entire pass-phrase or at least a portion of the pass-phrase (e.g., certain bits that form the master pass-phrase) should be identical to the pass-phrases implemented within other wireless devices that share the same mesh network.

After the mesh network has been created, the wireless device performs an Auto-IP Configuration process (item 650). The Auto-IP Configuration process is adapted to assign a unique IP address to the wireless device (and any subsequent wireless devices requesting to join the mesh network). The IP address is produced using the MAC address of the wireless device. For instance, according to one embodiment of the invention, the MAC address is used as a seed value for a pseudo-random generator that produces a resulting address within an predetermined address range (e.g., from address 192.168.0.1 to 192.168.254.254). After the IP address is assigned to the wireless device, the wireless device broadcasts the IP address over the mesh network and awaits a response that identifies that a collision has occurred (i.e. another wireless device has the same IP address). If so, using the MAC address, the wireless device regenerates the IP address and again conducts collision detection. If no collision is detected within a prescribed period of time, the IP address is now assigned to the wireless device for communications outside the mesh network.

Thereafter, when other wireless devices requesting connectivity to the mesh network established by the wireless device, a mesh authentication process will be conducted to confirm that the requesting wireless device is authenticated and may join the mesh network. This may be accomplished by encrypting a pass-code computed by a requesting wireless device with a public key of the wireless device as part of a Connection Request message (described below). The wireless device decrypts the encrypted pass-code and compares the result to a pass-code internally generated and stored therein. If the received pass-code matches the internally generated pass-code, the requesting wireless device has been authenticated.

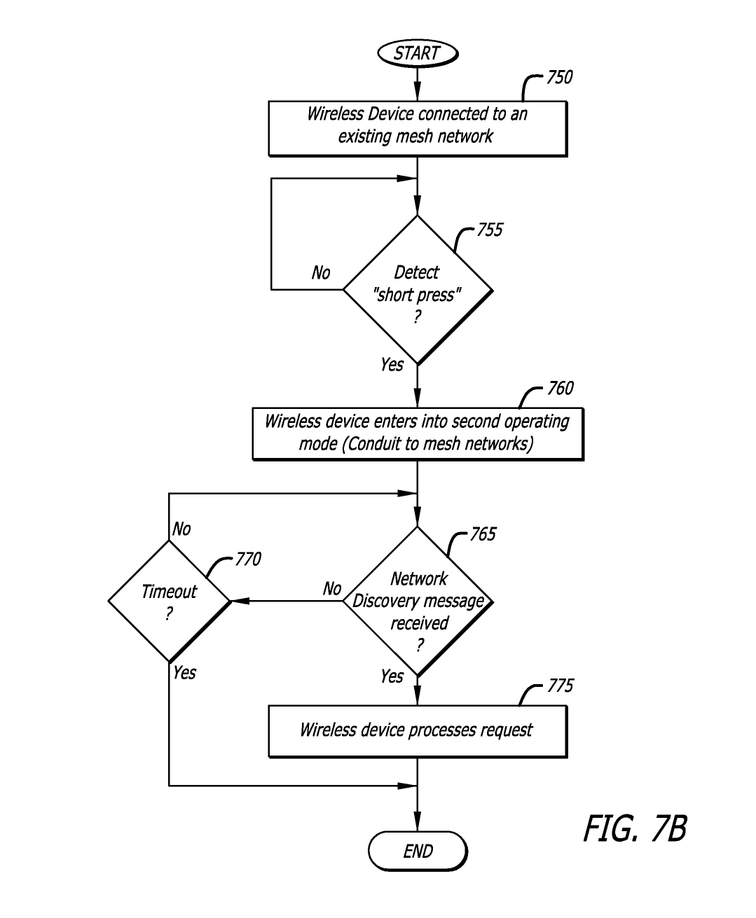

Referring to FIG. 7A, an exemplary embodiment of a flowchart outlining operations for joining an existing mesh network by a first (mesh-enabled) wireless device operating in a first operating mode is shown. As stated above, prior to attempting to join an existing mesh network, the wireless device undergoes a device configuration process to produce a master pass-phrase that is securely stored within the wireless device (item 700). Furthermore, the device is not part of an existing mesh network.

Upon detecting a different style of actuation of the mesh networking button, the wireless device is placed into a first operating mode referred to as a “Network Discovery mode” (items 705 and 710). Examples of a different style of actuation than already identified may include a “short press” being actuation of the mesh networking button for the second predetermined duration less than the first predetermined duration identified above, a single actuation, or the like. In Network Discovery mode, the wireless device transmits one or more messages over different wireless channels (item 715) in an effort to determine the presence of an existing mesh network that can be joined by the wireless device as described in more detail in FIG. 8.

In the event that a mesh network is located, the wireless device operates as a requesting device seeking to join the mesh network (items 720 & 725). Otherwise, if no mesh network is located and a timeout condition occurs, the Network Discovery protocol ends (item 730). If the connection is successful, however, the wireless device will conduct Mesh Authentication and Auto-IP Configuration protocols to authenticate a member of the mesh network and obtain an IP address (items 735 and 740).

FIG. 7B illustrates an exemplary embodiment of a flowchart outlining operations by a mesh-enabled wireless device for enabling another mesh-enabled wireless device to connect to an existing mesh network. Herein, upon detection of a “short press” of a mesh networking button of the wireless device and the wireless device is connected to an existing mesh network (items 750 & 755), the wireless device enters into the second operating mode by tuning to a particular channel and awaiting a Network Discovery Request message from another wireless device (item 760). If no such message is received before a predetermined period of time has elapsed (i.e. timeout condition), the wireless device exits the second operating mode (items 765 and 770). However, if the wireless device receives a Network Discovery Request message, the wireless device processes the request and responds accordingly (item 775) as set forth in FIG. 8.

Referring to FIG. 8, an embodiment of the process flow for mesh network detection using a pass-code between the first wireless device (Node A) 802 requesting connectivity to the existing mesh network and a second wireless device (Node B) 804 regulating connectivity to the existing mesh network. Herein, a determination is made whether any existing mesh networks are detected (item 805). For instance, according to one embodiment of the invention, when Node A 802 is powered on, it scans each wireless channel to detect the presence of other mesh networks and optionally categorizes the detected mesh networks based on signal strength (e.g. stronger RSSI first).

Given the growing popularity of wireless networks, there is a good chance that the scan result would detect the presence of several mesh networks in the vicinity of Node A 802. However, in order to accommodate for message loss, the wireless node (device) employs a message timer/retry mechanism that is configured to retry scanning for each wireless channel as needed, for up to “r” times where r≧1 (item 810). Where a requesting wireless device does not receive any replies before the timer expires “r” times, no mesh networks are determined to be communicating over a particular channel.

Upon detecting mesh networks, Node A 802 configures itself to match the channel and SSID settings of each such network (item 815) and sends a Network Discovery Request message 820 to Node B 804. According to one embodiment of the invention, Network Discovery Request message 820 is a broadcast or multicast message that a wireless device sends out in an attempt to find and join an existing mesh network as well as build a neighbor table including information concerning the detected wireless devices and their mesh (or ad hoc) networks.

As shown herein, Network Discovery Request message 820 includes a device type 821 and challenge text 822. “Challenge text” 822 is a secret value that contains 2^{k}-bits, where k≧5 (e.g., 2⁶ or 64-bits). According to one example, the secret value (8-bytes) is derived from a proprietary function that is utilized by a specific OEM, using a master pass-phrase and/or the extended service set identification (ESSID) of the network that Node A 802 is attempting to join. According to another example, the “challenge text” may be the secret value combined with one or more of (i) a current timestamp, (ii) an extended service set identification (ESSID) and/or (iii) a Network ID that Node A 802 is attempting to join. This “combination” may be implemented as a one or more Exclusive OR (XOR) operations, a concatenation, hash, or any arithmetic or logical operation on the data forming the secret value. The “device type” parameter 821 lets the receiving wireless device (Node B) know about Node A's capabilities.

| | | |
|---|---|---|
| #define GATEWAY | 1 | /*device type - Gateway*/ |
| #define STATIONARY | 2 | /*device type - Tier-2 Stationary |
| | | (default)*/ |
| #define MOBILE | 3 | /*device type - Tier-3 Mobile*/ |

In the event that the challenge text 822 does not match the expected result at Node B 804, Network Discovery Request message 820 is not processed further so that no response is generated. However, if a match is detected, Node B 804 associated with the mesh network transmits a Network Discovery Response message 830 to Node A 802.

As further illustrated in FIG. 8, Network Discovery Response message 830 contains a MAC address 831 of the wireless device that created the mesh network, a Network ID 832, and any other parameters required by Node A 802 to join the mesh network. Furthermore, Network Discovery Response message 830 includes (i) a public key (PUKB) 833 of the responding wireless device (Node B 804) for use in the Connection phase as additional security, (ii) a checksum 834 that is added to mitigate undetected corruption or tampering with PUBKB 833, which is most likely need in a man-in-the-middle attack. Public key checksum 834 may be computed as a hash result computed by hashing PUBK 833 using MD-5 or another hashing function. According to one embodiment of the invention, the keys (public/private pair) for the wireless devices are generated using OpenSSL (RSA keys). PUKB checksum 834 may be computed as a hash result computed by hashing PUBK 833 using OpenSSL functions (MD-5) or another hashing function. According to one embodiment of the invention, this key and checksum generation may occur at the manufacturer and at initialization of the wireless device. Optionally, another challenge text as a combination of the MAC address of Node A and the secret value may be provided for additional security.

Upon receiving Network Discovery Response message 830, Node A 802 checks the integrity of the message by comparing the received checksum 834 with the locally generated checksum for the received public key. Once the checksum is validated, Node A 802 stores PUKB 833, MAC address 831, MAC address of Node B, and other details for Node B.

During the Connection phase, Node A generates a Connection Request message 840 by automatically computing a pass-code based on both the pass-phrase securely stored in Node A 802 along with MAC address 831. The pass-code is encrypted using PUKB 833 and then is sent along with a checksum 842 of the encrypted pass-code 841, Node A's public key (PUKA) 843 and a checksum 844 of Node A's public key.

Upon receiving Connection Request message 840, Node B 804 checks for integrity by examining the encrypted pass-code checksum 841 with an internally generated checksum. If there is no disparity, Node B 804 decrypts the encrypted pass-code 841 and then checks the decrypted pass-code with its own pass-code. Thereafter, Node B 804 would send the Connection Confirm message 850 with a response code 852. Response code 852 serves as a feedback to Node A 802 that its request has been received with success or failure. The following gives a list of error codes.

| | |
|---|---|
| #define CONN_SUCCESS | 0 |
| #define PASSCODE_FAILED | 1 |
| #define ENC_CHKSUM_ERR | 2 |
| #define PUBKEY_CHKSUM_ERR | 3 |
| #define UNKNOWN_ERR | 4 |

The timeout and retry values for connection authentication process may be set as follows to set wait times for Connection Confirm message 850 and the number of retries for such transmissions:

| | | |
|---|---|---|
| #define TIMEOUT_CONN_REQ | 5 | /*5 seconds*/ |
| #define MAX_CONN_RETRY | 3 | |

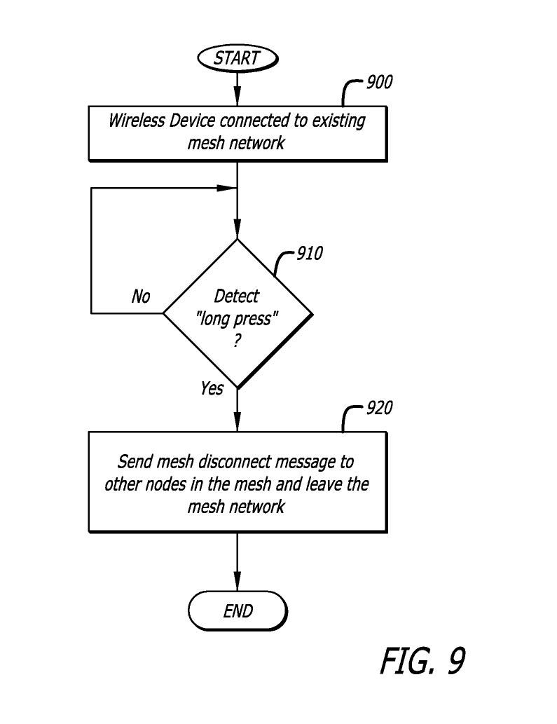

Referring now to FIG. 9, an exemplary embodiment of a flowchart outlining operations by a mesh-enabled wireless device for disconnecting from a mesh network is shown. When deciding to leave its mesh network, such determined from detection of a “long press” of the mesh networking button, a wireless device transmits (broadcasts or multicasts) a Disconnect message (items 900, 910 & 920). Neighboring wireless devices that receive a Disconnect message will remove the wireless device from their neighbor table that features addressing information for those wireless devices connected to the mesh network. To protect against fake Disconnect messages originating from non-OEM devices, the Disconnect message would include a security value derived from a proprietary logic functions that is OEM-specific. The inputs to the logic for formulating the security value may be the secret value and MAC address of the sending wireless device.

Several aspects of one implementation of the wireless home mesh network for providing improved home electronic device connectivity are described. However, various implementations of the wireless home mesh network provide numerous features including, complementing, supplementing, and/or replacing the features described above. These features can be implemented as part of wireless devices in different embodiment implementations. In addition, the foregoing description, for purposes of explanation, uses specific nomenclature to provide a thorough understanding of the embodiments of the invention. However, it will be apparent to one skilled in the art that the specific details are not required in order to practice the embodiments of the invention.

Having disclosed exemplary embodiments, it is contemplated that modifications and variations may be made to the disclosed embodiments while remaining within the scope of the embodiments of the invention as defined by the following claims.

What is claimed is:

1. A method comprising:
detecting a duration of time that a mesh networking button of a wireless device has been actuated; and
creating a first mesh network in response to actuation of the mesh networking button according to a first style of actuation, the first mesh network being created without additional input of information by a user.

2. The method of claim 1, wherein the first style of actuation includes actuation of the mesh networking button up to a first predetermined duration or by a first number of presses.

3. The method of claim 2 further comprising:
requesting to join a second mesh network in response to actuation of the mesh networking button according to a second style of actuation being at least a second predetermined duration or a second number of press, the second predetermined duration being longer in time than the first predetermined duration and the second number of presses being greater in number than the first number of presses.

4. The method of claim 3, wherein the requesting to join the second mesh network comprises transmitting a first message to identify that the wireless device is permitted to access the network, and if the wireless device is permitted to access the network, receiving a second message from a wireless device being part of the second mesh network, the second message including an identifier of a wireless device forming the second mesh network.

5. The method of claim 4, wherein the identifier is a media access control (MAC) address of the wireless device forming the second mesh network.

6. The method of claim 5, wherein the first message includes (i) a device type that identifies capabilities of the wireless device and (ii) information including a secret value that is derived in accordance with a function selected by a provider of the wireless device and replicated by the wireless device being part of the second mesh network.

7. The method of claim 4 further comprising transmitting a third message including a pass-code encrypted with a public device of the wireless device being part of the second mesh network, the pass-code being generated from the identifier of the wireless device forming the second mesh network and information input by the user at initial set-up of the wireless device.

8. The method of claim 7, wherein the third message further comprises a checksum of the encrypted pass-code.

9. The method of claim 2, wherein the detecting of the duration of time that the mesh networking button of the wireless device has been actuated is performed by at least one counter implemented within the wireless device, the at least one counter providing a count value representing a period of time less than or equal to the first predetermined duration to a processor within the wireless device, the processor to activate network formation logic within the wireless device.

10. The method of claim 2, wherein the detecting of the duration of time that the mesh networking button of the wireless device has been actuated is performed by at least one counter implemented within the wireless device, the at least one counter providing a count value representing the duration to a processor within the wireless device that activates either (1) network discovery logic within the wireless device if the count value represents a time period greater than or equal to the second predetermined duration and (ii) network formation logic within the wireless device if the count value represents a time period less than or equal to the first predetermined duration.

11. The method of claim 3 further comprising:
if the wireless device is currently connected to an existing mesh network, disconnecting the wireless device from the existing mesh network in response to actuation of the mesh networking button for at least the second predetermined duration.

12. Adapted for communications with another wireless device of a mesh network, a wireless device comprising:
a user interface unit,
a processor;
a chipset coupled to the processor and the user interface unit;
a networking logic coupled to the chipset, the networking logic including
a network formation logic to create a mesh network for the wireless device without additional input of information by a user in response to actuation of the user interface unit according to a first style of actuation, and
a network discovery logic to enable the wireless device to join an existing mesh network in response to actuation of the user interface unit according to a second style of actuation that differs from the first style of actuation.

13. The wireless device of claim 12, wherein the first style of actuation is actuation of the user interface unit for at least a first predetermined duration and the second style of actuation is actuation of the user interface unit for at least a second predetermined duration, the second predetermined duration being longer in time than the first predetermined duration.

14. The wireless device of claim 13, wherein the network discovery logic to prompt issuance of a request to join the existing mesh network in response to actuation of the user interface unit by transmitting a first message to identify that the wireless device is permitted to access the network, and if the wireless device is permitted to access the existing mesh network, receiving a second message from a wireless device being part of the existing mesh network, the second message including an identifier of a wireless device forming the existing mesh network.

15. The wireless device of claim 14, wherein the identifier is a media access control (MAC) address of the wireless device forming the second mesh network.

16. The wireless device of claim 14, wherein the first message includes (i) a device type that identifies capabilities of the wireless device and (ii) information including a secret value that is derived in accordance with a function selected by a provider of the wireless device and replicated by the wireless device being part of the existing mesh network.

17. The wireless device of claim 14 further comprising transmitting a third message including a pass-code encrypted with a public device of the wireless device being part of the existing mesh network, the pass-code being generated from the identifier of the wireless device forming the existing mesh network and information input by the user at initial set-up of the wireless device.

18. The wireless device of claim 17, wherein the third message further comprises a checksum of the encrypted pass-code.

19. The wireless device of claim 13 further comprising at least one counter that detects a duration of time that the mesh networking button of the wireless device has been actuated and provides a count value representing a period of time less than or equal to the first predetermined duration to the processor that assists in activating the network formation logic.

20. A non-transitory storage medium that contains a program, executed by a processor, to perform a plurality of operations, comprising:
detecting a duration of time that a mesh networking button of a wireless device has been actuated; and
creating a first mesh network in response to actuation of the mesh networking button up to a first predetermined duration, the first mesh network being created without additional input of information by a user.
